(19) United States
(12) Patent Application Publication
(10) Pub. No.: US 2013/0031232 A1
(43) Pub. Date: Jan. 31, 2013

(54) System and Method For Sharing Electronic Information

(71) Applicants: Robert Clymer, Calabasas, CA (US); Robert Gregory, Calabasas, CA (US); Robert Atlas, Calabasas, CA (US); Preston Law, Calabasas, CA (US)

(72) Inventors: Robert Clymer, Calabasas, CA (US); Robert Gregory, Calabasas, CA (US); Robert Atlas, Calabasas, CA (US); Preston Law, Calabasas, CA (US)

(21) Appl. No.: 13/556,560

(22) Filed: Sep. 27, 2012

Related U.S. Application Data
(60) Provisional application No. 61/511,364, filed on Jul. 25, 2011.

(51) Int. Cl. G06F 15/16

(52) U.S. Cl. 709/223

(57) ABSTRACT

In one embodiment, the present invention provides a system for interfacing at least one requestor to at least one performer, wherein the at least one requestor is able to transfer electronic data, or portions thereof, ubiquitously with at least one performer, regardless of the format that the at least one requestor and the at least one performer manage their respective electronic information. In particular, the present invention provides a system, wherein the at least one requestor and the at least one performer update electronic, and/ or modify electronic information, or portions thereof, dynamically, in response to requests and responses from at the at least one requestor and the at least one performer. At any given time, any requestor may become a performer and vice versa.

This application claims priority to Provisional U.S. Patent Application Ser. No. 61/511,364, filed Jul. 25, 2011.

### FIELD OF THE INVENTION

In one embodiment, the present invention provides a system for interfacing at least one requestor to at least one performer, wherein the at least one requestor is able to transfer electronic data, or portions thereof, ubiquitously with at least one performer, regardless of the format that the at least one requestor and the at least one performer manage their respective electronic information. In particular, the present invention provides a system, wherein the at least one requestor and the at least one performer update electronic, and/ or modify electronic information, or portions thereof, dynamically, in response to requests and responses from at the at least one requestor and the at least one performer. At any given time, any requestor may become a performer and vice versa.

### BACKGROUND

Issues with combining heterogeneous data sources under a single query interface have existed for some time. The rapid adoption of databases has led to the need to share or to merge existing repositories. This merging can take place at several levels in the database architecture. For example, one solution involves data warehousing. In data warehousing, a warehouse system extracts, transforms, and loads data from heterogeneous sources into a single common queriable schema so data becomes compatible with each other. This approach offers a tightly coupled architecture because the data is already physically reconciled in a single repository at query-time. However, problems arise with the “freshness” of data, which means information in the warehouse is not always up-to-date.

Combining heterogeneous data sources efficiently and accurately is essential, for example, to prevent loss of data, and to minimize cost. One industry where there has been a significant need to combine heterogeneous data sources is the healthcare industry. In particular, there has been a significant effort to create databases of patient's medical records, and allow the transfer of data within those databases amongst healthcare providers.

Information contained in a patient's medical record allows healthcare providers to provide continuity of care to individual patients. The medical record also serves as a basis for planning patient care, documenting communication between the patient, the healthcare provider and any other health professional contributing to the patient's care.

The effective storage, retrieval and management of patient information is required to provide effective and efficient health care services. Paper-based records are cumbersome and expensive to distribute between multiple healthcare providers. Some integrated software systems for keeping sensitive records electronically have been developed for the storage of electronic medical records (“EMR”). EMRs have several distinct advantages over paper-based records: For example, the storage of EMRs is more efficient than paper-based systems. Furthermore, an EMR is accessible from remote sites by many healthcare providers, and retrieval of that information is almost immediate.

In one example, U.S. Pat. No. 5,644,778 discloses a medical transaction system that is capable of permitting a plurality of healthcare providers to communicate with a plurality of payors and financial institutions.

In another example, U.S. Pat. No. 6,453,297 discloses a medical transaction system that is capable of permitting a plurality of healthcare providers to communicate with a plurality of payors and financial institutions.

In another example, US Patent Application No. US20020145634A1 discloses a multimedia computerized patient medical record system that employs an interactive graphic user interface. US Patent Application No. US20020145634A1 states “The patient medical record system organizes data entry, retrieval and presentation to enhance the ability of specialized medical professionals in more efficiently and successfully completing medical decisions, and thus deliver improved patient healthcare.”

In another example, U.S. Pat. No. 7,275,220 discloses an electronic health care system [including] a modular framework and a display in communication with the modular framework for providing a graphical user interface to a system user. The modular framework includes a plurality of activities, each activity providing an aspect of patient care, where the framework is adaptable for accepting additional activities forming a single integrated system. The graphical user interface is adaptable for displaying information corresponding to one or more of the activities, and includes a common menu format for communicating available operations in the graphical user interface, and common visual components for displaying information to a system user.

In another example, US Patent Application No. US20040078229A1 discloses a medical record management system and method capable of providing patients and CDOs with secure access to medical information.

In another example, WO2004051415A2 discloses a computer-implemented method for integrating information into a medical workflow process. The method includes receiving data associated with a patient, initiating a computer search of information based on the received data associated with the patient, receiving search results from the computer search of information, and integrating the search results into the medical workflow process.

In another example, US Patent Application No. US20070078688A1 discloses a system allowing a person to carry with them a means for identifying themselves and enabling a service provider to access private data about the person.

In another example, US Patent Application No. US20100063845A1 discloses methods and systems for providing patient and healthcare providers with access to a patient EHR.

In another example, WO2009117655A2 discloses a medical records network configured for communicating a plurality of electronic medical records over authenticated peer-to-peer connections among a plurality of client computer systems.

In another example, US Patent Application No. US20100030580A1 discloses a Physician To Patient (P2P) network system, a private & secure infrastructure for independently practicing physicians and patients for real-time electronic communication [and] transfer of patient health information is disclosed by the invention.

In another example, US Patent Application No. US20110099024A1 discloses a computer useable medium encoded with a computer program for maintaining an electronic healthcare database, the medium comprising: a) a computer database for maintaining personal and medical records of a patient; b) means for remotely accessing said database to at least one provider of medical care for the patient; c) records of personal and medical information entered into said database by the provider; and d) an algorithm program for relating a diagnosed medical condition of the patient and at least one medical care action relating to the patient.

In another example, US Patent Application No. US20110153359A1 discloses a system and method [for] gathering patient treatment information in summary form from a universe of health care providers, each using any form of patient information management; converting that information to pointers that can be searched by a healthcare provider before or during treatment to determine if further information needs to be acquired from the original provider; and a variety of methods to provide access to detailed healthcare treatment and diagnosis information from the original healthcare provider through an access and display method provided by the healthcare provider housing the records, if available.

In another example, US Patent Application No. US20110004071A1 discloses methods, systems, devices and/or apparatus related to displaying and visualizing medical information for facilitating effective analysis by medical professionals.

In another example, US Patent Application No. US20100325694A1 discloses a method of centralized identity authentication for use in connection with a communications network includes registering users of the communications network such that each registered user's identity is uniquely defined and determinable, and registering a plurality of vendors having a presence on the communications network.

In another example, US Patent Application No. US20110004491A1 discloses an apparatus for medical recordkeeping [including] at least a first web server, at least a first processor in communication with the first web server, and a communications terminal connecting the web server with a network. The apparatus further includes at least a first memory in electrical communication with the processor. The first memory stores a plurality of medical records including at least a first entry indicative of a patient contact with at least a first service provider. Each successive patient contact is recorded onto the medical record responsive to the patient contact.

In another example, US Patent Application No. US20110106564A1 discloses an electronic medical record system. US20110106564A1 states “A clinical web server connects to at least two information technology systems and providing real time exchange of data between existing databases. The clinical web server translates and maps existing databases into a common data structure format. A message to be transmitted is generated. Routing type and formatting routing are determined based on recipient delivery requirements. The message is parsed into segments and fields. The appropriate party to whom the message is directed is determined. Identifiers in the message are translated from a sender's value to a recipient's value. The message is translated from a sender's format to a recipient's format.”

In another example, US Patent Application No. US20110119089A1 discloses an electronic medical record system and method [enabling] a patient and the patient's caregivers to create, maintain, and use an electronic medical record over a secured communication network, such as the Internet.

In another example, US Patent Application No. US20110153364A1 discloses a method for gathering patient treatment information in summary form from a universe of health care providers, each using any form of patient information management; converting that information to pointers that can be searched by a healthcare provider before or during treatment to determine if further information needs to be acquired from the original provider; and a variety of methods to provide access to detailed healthcare treatment and diagnosis information from the original healthcare provider through an access and display method provided by the healthcare provider housing the records, if available.

In another example, U.S. Pat. No. 7,940,753 discloses a method of enhancing routing optimality in IP networks requiring path establishment, comprising: a path computational element automatically computing an explicit optimal network route between a first communication element in a first network cloud and a second communication element in a second network cloud using a network configuration of the first and second network clouds, the first network cloud and the second network cloud each including a plurality of communication elements, and each having boundaries beyond which each of the plurality of communication elements in each network cloud are unable to see a connectivity between any other communication elements outside each respective network cloud, the path computational element having an overview of all communication elements in the network clouds; the path computational element providing the computed explicit optimal network route to a routing engine; commissioning a path through the first network cloud and the second network cloud from the first communication element to the second communication element using the provided explicit optimal network route; establishing a path using the computed explicit optimal network route; switching to an alternative route that is inferior to the computed explicit optimal network route upon a failure of the computed explicit optimal network route to function properly; attempting to renegotiate the commissioned path to the computed explicit optimal network route; determining that the explicit optimal network route is again available; and switching the commissioned path back to the computed explicit optimal network route when that route is determined to be again available.

In another example, U.S. Pat. No. 7,886,038 discloses a method of managing identity in a cloud computing environment, comprising: receiving a request to instantiate identity management services in the cloud computing environment from an operator of a set of managed machines; instantiating the identity management services in the cloud computing environment for the set of managed machines; receiving identity information from at least one system linked to the identity management services; and storing the identity information from the at least one system in the identity management services in the cloud computing environment.

In another example, US Patent Application No. US20110119729A1 discloses a method implemented in a non-transitory machine-readable storage medium and processed by one or more processors configured to perform the method, comprising: configuring a first process within a first cloud computing environment to manage select messages occurring within a communication channel within the first cloud computing environment; instantiating the first cloud computing environment with the first process executing therein; and enforcing, by the first process, selective policy restrictions based on the select messages that enter and exit the communication channel.

In another example, US Patent Application No. US20110119481A1 discloses a method for hosting data, comprising: receiving, by at least one computing device in a first region of control from at least one computing device in a second region of control, obscured data formed from at least one first mathematical transformation of data for a defined data set of the at least one computing device in the second region of control; receiving, by the at least one computing device in the first region of control, obscured metadata formed from an analysis of the data and at least one second mathematical transformation of an output of the analysis; and determining at least one container of a plurality of containers of at least two disparate container types in which to store at least one of the obscured data or the obscured metadata.

In another example, US Patent Application No. US20110072487A1 discloses a system comprising one or more processors coupled to a memory, the one or more processors when executing logic encoded in the memory providing: a topology manager, configured to: maintain a security topology of a plurality of hosts, the security topology associating one or more virtual host policies with a plurality of virtual hosts in a cloud computing deployment; and request a query for one or more hosts that are candidates to be enforced (candidate hosts); and a portability manager, configured to: receive a request to deploy an access control agent on the one or more candidate hosts; determine an optimal agent to be deployed from a list of available agents; and deploy the optimal agent on the one or more candidate hosts.

In another example, WO2006122126A3 discloses a database translation architecture that has an object model for defining a variety of health-related classes and a plurality of data bridge/data set pairs wherein each data bridge is coupled to the object model. A plurality of external components are coupled to all but one of the data bridge/data set pairs of the plurality of data bridge/data set pairs wherein the plurality of external components are operative to send and receive data in formats unique to each external component such that each format is translated to and from the object model by each corresponding data bridge/data set pair. Also included is a database coupled to a remaining data bridge/data set pair not coupled to an external component wherein the database is responsive to data queries from the object model as translated by the remaining data bridge/data pair and the database and operative to deliver requested data back to the object model through the remaining data bridge/data set pair which is in turn sent to an external component that originally initiated the data query.

In another example, US Patent Application No. US20100179827A1 discloses a method, system, and medium . . . for searching an electronic medical record. Search results are returned in response to a search query. The search query may be one or more designated medical concepts. The search results may be displayed according to a ranking that determines which search results are likely to be the most responsive to a query submitted by a particular clinician based on matching the most important clinical concepts in each document to the most important clinical concepts in the search query.

In another example, US Patent Application No. US20010049610A1 discloses an electronic medical record information management system and an electronic medical record information management method, in which a medical institute such as a medical practitioner and a small hospital, which have some difficulty to introduce and operate a large electronic medical record information management system, can use . . . . A user makes electronic medical records of patients by using an electronic medical record terminal in a hospital information system, and transmits the electronic medical records of the patients made at the electronic medical record terminal to an electronic medical record information management center system. The user requests to transmit an electronic medical record of a patient storing in the electronic medical record information management center system. A control server in the electronic medical record information management center system takes out the electronic medical record of the patient requested by the user from an electronic medical record storing server in the electronic medical record information management center system, and transmits this electronic medical record of the patient to the hospital information system. The electronic medical record terminal shows this electronic medical record of the patient to the user. The electronic medical record terminal also transmits an electronic medical terminal added new information to the electronic medical record information management center system. The control server makes the electronic medical record storing server store this electronic medical record added the new information.

In another example, US Patent Application No. US20050187794A1 discloses an electronic medical record registry system, comprising a display program capable of displaying a registered electronic medical record, a plurality of medical service provider databases, each medical service provider database comprising of a plurality of electronic medical records, each electronic medical record including information indicative of a patient history associated with the respective medical service provider, and a registry repository, having a main registry database with a plurality of registered electronic medical records. The invention may also include a match/merge program capable of deduplicating the electronic medical records associated with the medical service provider databases, based on unique patient information, to form the registered electronic medical record with the most complete patient history.

However, the implementation of EMR's has been slowed by several problems: For example, EMR's are often localized to a particular doctor or facility, and a patient may have separate and unique medical records at several facilities, the format and content of which may be inconsistent. Consequently, a doctor may not have access to a patient's full medical history. Furthermore, there are concerns over privacy of the information being transferred, and the start-up costs of implementing an EMR system is often high. There remains a need for an electronic health record management system that allows the secure transfer of patient data between service providers.

### SUMMARY

In one embodiment, the present invention provides a system that interfaces at least one requestor to at least one performer, wherein the at least one requestor is able to transfer electronic information, or portions thereof, ubiquitously with the at least one performer, such that the at least one performer and the at least one requestor receive the electronic information transferred in a format that they can manage the electronic information regardless of the format that the at least one requestor and the at least one performer manage their respective electronic information.

In one embodiment, instructions related to processes and procedures that modify the electronic information also are part of the electronic information transferred.

In one embodiment, the present invention provides a system for interfacing at least one requestor to at least one performer, wherein the at least one requestor is able to transfer instructions related to processes and procedures that modify electronic information to the at least one performer such that the at least one performer and the at least one requestor receive the electronic information transferred in a format that they can manage the electronic information regardless of the format that the at least one requestor and the at least one performer manage their respective electronic information.

In one embodiment, the electronic information is electronic medical records.

In one embodiment, the at least one requestor is a physician practice.

In one embodiment, the at least one performer is a performing diagnostic testing service provider, such as a clinical medical laboratory.

### BRIEF DESCRIPTION OF THE DRAWINGS

FIG. 1 shows a graphical representation of a traditional means by which a requestor connects to at least one performer via a point-to point interface.

FIG. 2 shows a graphical representation of one embodiment of the system of the present invention.

FIG. 3 shows a graphical representation of a traditional means by which a physician practice connects to at least one performing medical laboratory or diagnostic testing services center via a point-to point interface.

FIG. 4 shows a graphical representation of one embodiment of the system of the present invention, wherein more than one physician practice is connected to more than one performing diagnostic testing services center without using a point-to-point interface.

FIG. 5 shows a graphical representation of one embodiment of the system of the present invention, detailing data transfer mechanisms.

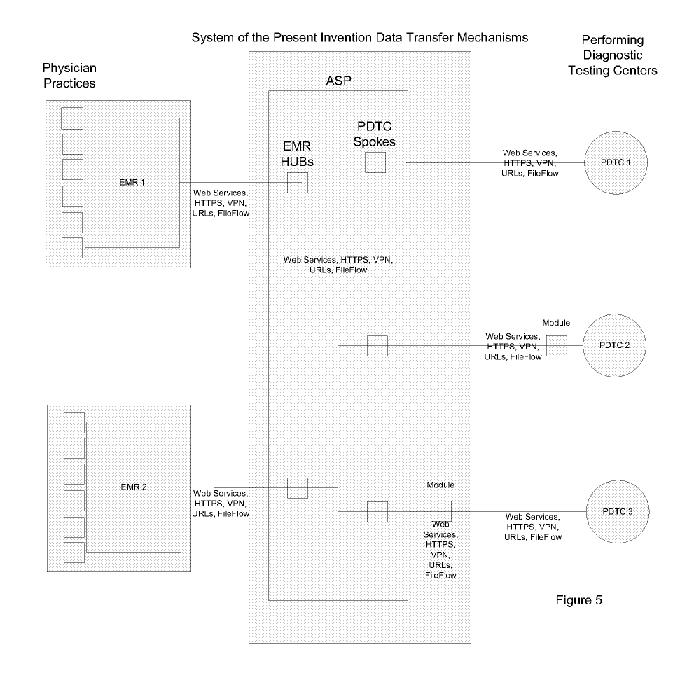

FIG. 6 shows a graphical representation of one embodiment of the system of the present invention detailing file flow between more than one physician practice and more than one performing diagnostic testing services center.

FIG. 7 shows a graphical representation of one embodiment of the system of the present invention detailing file flow within an EMR hub.

FIG. 8 shows a graphical representation of one embodiment of the system of the present invention detailing file flow within a performing diagnostic testing center spoke.

FIG. 9 shows a graphical representation of one embodiment of the system of the present invention detailing data flow contemplating additional software module(s).

FIG. 10 shows a graphical representation of one embodiment of the system of the present invention detailing data flow.

### DETAILED DESCRIPTION

For clarity of disclosure, and not by way of limitation, the detailed description of the invention is divided into the following subsections that describe or illustrate certain features, embodiments or applications of the present invention.

### Definitions

“Requestor” as used herein refers to a subscriber to a software system that manages electronic information that sends instructions or other electronic data to a performer.

“Performer” as used herein refers to a recipient of instructions or other electronic data from a requestor, who then acts on the instructions. For clarity of disclosure, such actions may include but are not limited to, requesting further or more detailed instructions in which case, the performer becomes a requestor, or, the performer may perform according to the instructions and transfer back electronic information resulting from such performance.

“Medical record” as used herein refers to the documentation of the body of information, or any portion thereof, that comprises a patient's individual medical history and care, including, but not limited to information sufficient to identify the patient, information on medical encounters, orders and prescriptions, history of the present illness/ complaint, previous illnesses, diagnoses, prognoses, physical examinations, x-rays, lab test results, digital images of the patient, informed consent forms, insurance information, billing records and the like.

“Electronic medical record”, or “EMR” as used herein refers to a computerized record, or any portion thereof, of the documentation of a patient's medical record.

“Healthcare provider” as used herein means an organization, entity, or individual, such as, for example, a hospital, clinical laboratory, physician, insurance company, that provides any treatment or services related to the treatment of a patient.

“S#” as used herein refers to the Requestor's system number.

“P#” as used herein refers to the performer number.

“EMR” as used herein refers to an electronic medical record.

“PDTC” as used herein refers to a performing diagnostic testing center.

“ASP” as used herein refers to an application service provider.

“IE” as used herein refers to an interface engine.

“EOS” as used herein refers to an external ordering system.

“LIS” as used herein refers to a laboratory information system.

“ADT” as used herein refers to an admission discharge transaction.

“DB” as used herein refers to a database.

“HL7” as used herein refers to health level seven.

### The System of the Present Invention

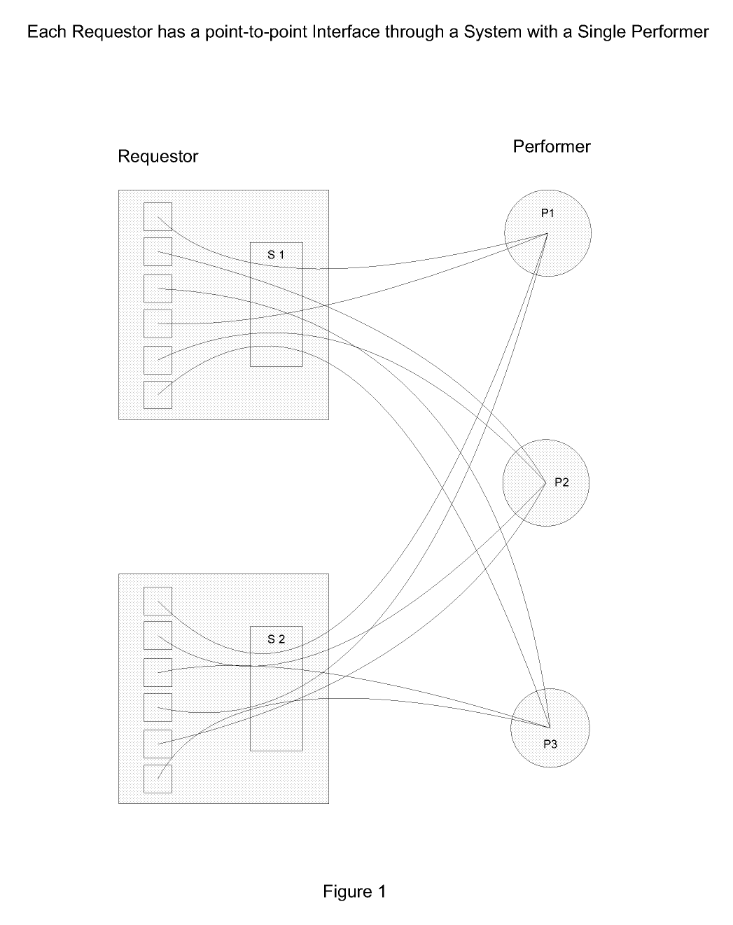

FIG. 1 shows a graphical representation of a traditional means by which a requestor connects to at least one performer. In the traditional means, each requestor requires a point-to-point interface through a system with a single performer. This leads to a highly complex network of connections.

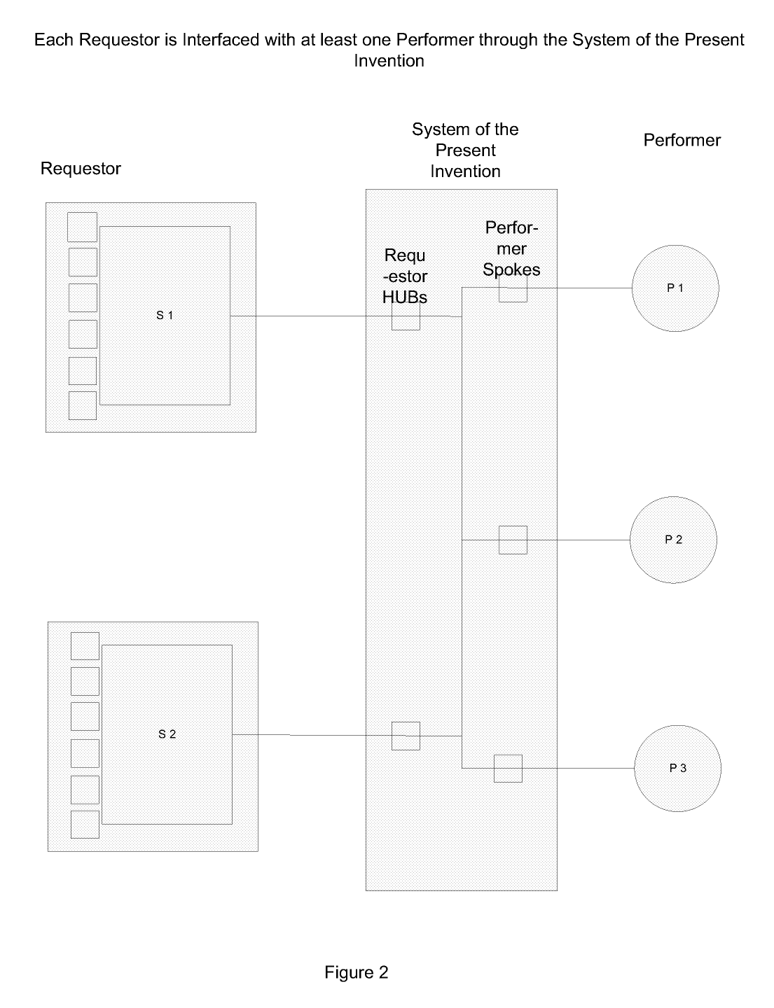

In contrast, FIG. 2 shows one embodiment of the system of the present invention, wherein at least one requestor is interfaced with at least one performer, through the system of the present invention. The system of the present invention is capable of connecting an infinite number of requestors to an infinite number of performers without traditional point-to-point connections, and understanding that a requestor and a performer may interchange at any given time. The requestor interfaces to the system of the present invention through their software system interface. Each requestor is able to transfer electronic data, or portions thereof, together with the instructions needed to facilitate the process and workflow necessary by the at least one performer in a manner that is perceived as being in a local format, structure and terminology/ language. The system of the present invention receives the request for electronic information from the at least one requestor through a requestor hub. The request contains instructions that direct the information to the at least one performer. The requestor hub normalizes the request to the system of the present invention. In turn, the system routes the normalized request to the spoke corresponding to the at least one performer the at least one requestor directed the request to, using the instructions in the request. The spoke then converts the request to a format understood by the at least one performer and delivers the request to the at least one performer via the performer spoke and performer system. The at least one performer processes the request and sends back a response. The system of the present invention transmits the response through the performer spoke. The response contains instructions that route the response to the at least one requestor. The performer spoke normalizes the response to the system of the present invention. In turn, the spoke routes the normalized response to the at least one requestor, via its corresponding requestor hub, using the instructions in the response. The requestor hub then converts the response to a format understood by the at least one requestor and delivers the response to the at least one requestor.

In one embodiment, the requestor does not use the system of the present invention to send a request to a performer. For example, the requestor may use an alternate form of communication, such as a facsimile, electronic mail, letter, and the like. However, the performer utilizes the system of the present invention to respond. In an alternate embodiment, the requestor uses the system of the present invention to send a request to a performer, and the performer does not use the system of the present invention to send a response. For example, the performer may use an alternate form of communication, such as a manual requisition, a facsimile, electronic mail, letter, and the like.

The transfer of electronic information, or portions thereof, or instructions from the at least one requestor to the requestor hub may be via any method contemplated by one of ordinary skill in the art, such as, for example, HTTPS, VPN, web services, URL, or file flow.

The transfer of electronic information, or portions thereof, or instructions from the spoke to the at least one performer may be via any method contemplated by one of ordinary skill in the art, such as, for example, HTTPS, VPN, web services, URL, or file flow.

The transfer of electronic information, or portions thereof, or instructions from the requestor hub to the spoke may be via any method contemplated by one of ordinary skill in the art, such as, for example, HTTPS, VPN, web services, URL, or file flow.

The electronic information may be any form of data capable of being manipulated electronically, such as, for example, text, images, video, audio, or any combination thereof.

In one embodiment, the at least one requestor sends instructions to at least one performer, requiring the at least one performer transmit back specific data. The at least one performer may do so without requiring additional data from the at least one requestor. Alternatively, the at least one performer may require additional data from the at least one requestor. In the case where the at least one performer requires additional data from the at least one requestor, the at least one performer sends instructions back to the at least one requestor, requiring the at least one requestor transmit back specific data. In these embodiments, the at least one requestor is first a requestor, then is a performer, and the at least one performer is first a performer, then a requestor.

In one embodiment, the system of the present invention is capable of facilitating the unidirectional, or bi-directional transfer of electronic information, portions thereof, or instructions.

In one embodiment, the at least one requestor may be both a requestor and a performer. In an alternate embodiment, the at least one requestor may be a requestor, then a performer.

In one embodiment, the at least one performer may be both a performer and a requestor. In an alternate embodiment, the at least one performer may be a performer then a requestor. In electronic information transactions, any sequence of performer and requestor may occur.

### The System of the Present Invention, Wherein the Electronic Information Being Transferred is Electronic Medical Records

In one embodiment, the electronic information transferred by the system of the present invention is electronic medical records. In the embodiments where electronic medical records are being transferred using the system of the present invention, the requestors and the performers are healthcare providers. In accordance with the principles of the present invention, the many, various, and disparate systems of healthcare providers intercommunicate and interoperate easily and securely, regardless of the format that the requestor and performer manage their respective electronic medical records, without traditional point-to-point connections.

In one embodiment, the electronic information transferred by the system of the present invention is electronic medical records, or portions thereof, as well as instructions related to processes and procedures that may enhance or modify the data contained in the electronic medical record, thus facilitating the dynamic updating of any patient complete electronic medical record to the most current diagnostic view.

While one of ordinary skill in the art can appreciate the many embodiments of the system of the present invention; for clarity operation of the system of the present invention is described in detail below using the transfer of electronic information consisting of electronic medical records or portions thereof. Even using this limited example, one of ordinary skill in the art can appreciate that a requestor can be a physician practice or a referring laboratory. For clarity, but not intending to limit the scope of the invention, the following examples utilize a physician practice as the requestor.

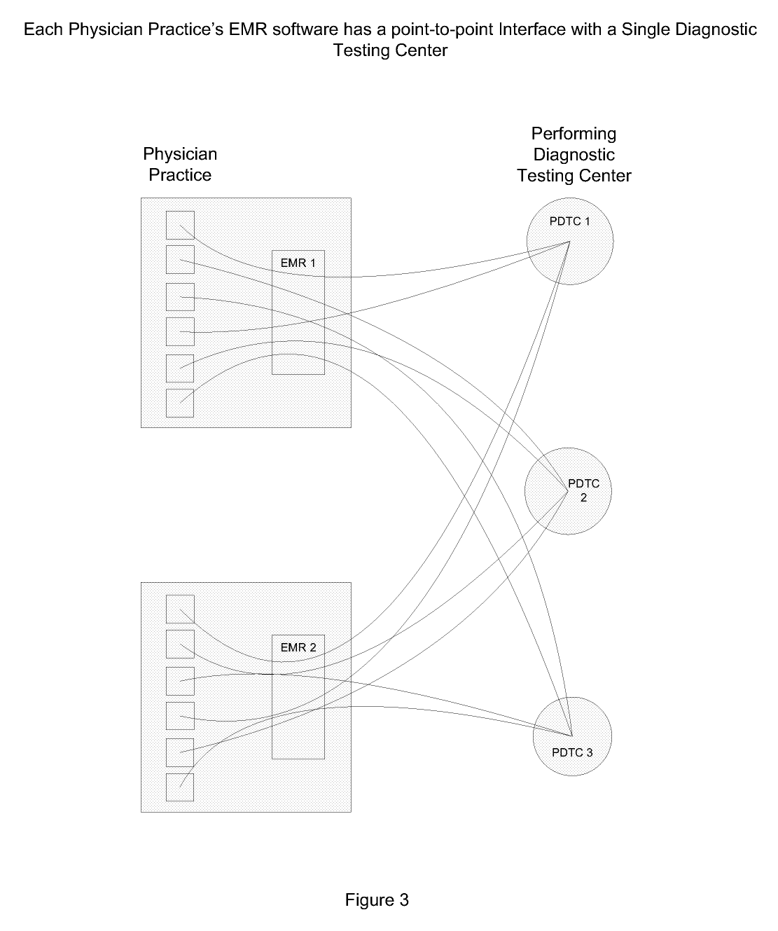

FIG. 3 shows a graphical representation of a traditional means by which physician practices connect to at least one performing diagnostic testing services center. In the traditional means, each physician practice requires a point-to-point interface through an EMR software system with a single performing diagnostic testing services center. This leads to a highly complex network of connections.

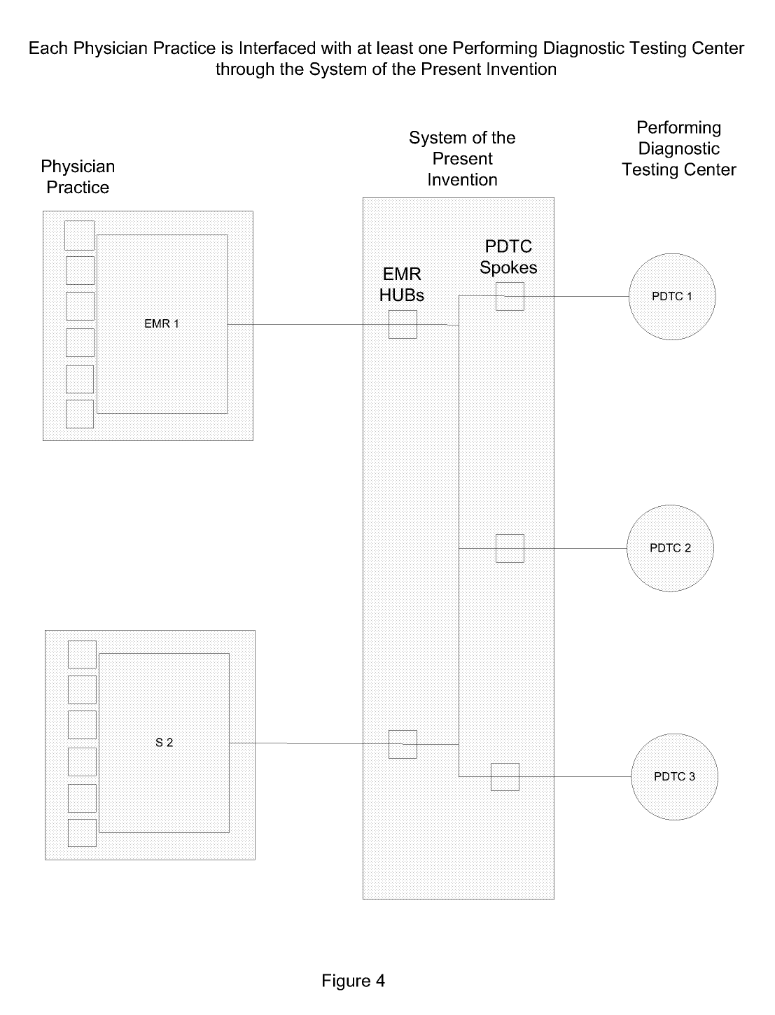

In contrast, FIG. 4 shows one embodiment of the system of the present invention, wherein at least one physician practice is interfaced with at least one performing diagnostic testing services center, through the system of the present invention. The system of the present invention is capable of connecting an infinite number of physician practices to an infinite number of performing diagnostic testing services centers without traditional point-to-point connections. The at least one physician practice interfaces to the system of the present invention through their EMR software system interface. The at least one physician practice is able to transfer electronic medical records, or portions thereof, together with the instructions needed to facilitate the process and workflow necessary by the at least one performing diagnostic testing services center, in manner that is perceived as being in a local format, structure and terminology/language. The system of the present invention receives the request for electronic medical records or portions thereof from the at least one physician practice through an EMR hub. The request contains instructions that direct the information to the at least one performing diagnostic testing services center. The EMR hub normalizes the request to the system of the present invention. In turn, the system routes the normalized request to the spoke corresponding to the at least one performing diagnostic testing services center the at least one physician practice directed the request to, using the instructions in the request. The spoke then converts the request to a format understood by the performing diagnostic testing services center. The at least one performing diagnostic testing services center processes the request and sends back a response. The system of the present invention transmits the response through the spoke corresponding to the performing diagnostic testing services center. The response contains instructions that route the response to the at least one physician practice. The spoke normalizes the response to the system of the present invention. In turn, the spoke routes the normalized response to the at least one physician practice, via its corresponding EMR hub, using the instructions in the response. The EMR hub then converts the response to a format understood by the at least one physician practice and delivers the response to the at least one physician practice.

In one embodiment, the at least one physician practice does not use the system of the present invention to send a request to a performing diagnostic testing services center. For example, the at least one physician practice may use an alternate form of communication, such as a facsimile, electronic mail, letter, and the like. However, the performing diagnostic testing services center utilizes the system of the present invention to respond. In an alternate embodiment, the at least one physician practice uses the system of the present invention to send a request to a performing diagnostic testing services center, and the performing diagnostic testing services center does not use the system of the present invention to send a response. For example, the performing diagnostic testing services center may use an alternate form of communication, such as a manual requisition, a facsimile, electronic mail, letter, and the like.

The transfer of electronic medical records, or portions thereof, or instructions from the at least one physician practice to the EMR hub may be via any method contemplated by one of ordinary skill in the art, such as, for example, HTTPS, VPN, web services, URL, or file flow.

The transfer of electronic medical records, or portions thereof, or instructions from the spoke to the at least one performing diagnostic testing services provider may be via any method contemplated by one of ordinary skill in the art, such as, for example, HTTPS, VPN, web services, URL, or file flow.

The transfer of electronic medical records, or portions thereof, or instructions from the EMR hub to the spoke may be via any method contemplated by one of ordinary skill in the art, such as, for example, HTTPS, VPN, web services, URL, or file flow.

In one embodiment, the at least one physician practice sends instructions to at least one performing diagnostic testing services provider, requiring the at least one performing diagnostic testing services provider to transmit back specific data. The at least one performing diagnostic testing services provider may do so without requiring additional data from the at least one physician practice. Alternatively, the at least one performing diagnostic testing services provider may require additional data from the at least one physician practice. In the case where the at least one performing diagnostic testing services provider requires additional data from the at least one physician practice, the at least one performing diagnostic testing services provider sends instructions back to the at least one physician practice, requiring the at least one physician practice transmit back specific data. In these embodiments, the at least one physician practice is first a requestor, then is a performer, and the at least one performing diagnostic testing services provider is first a performer, then a requestor.

For example, the at least one physician practice may transmit an order for a test to be performed on a patient at least one performing diagnostic testing services provider. The at least one performing diagnostic testing services provider may require additional information on the patient or test, such as, for example, previous medical conditions, medications, parameters of the test, and the like, in order to perform the test. The at least one performing diagnostic testing services provider may transmit a request back to the at least one physician practice for the additional information. In doing so, the at least one performing diagnostic testing services provider is first a performer, then a requestor, and the at least one physician practice is first a requestor then a performer.

In one embodiment, the system of the present invention is capable of facilitating the unidirectional, or bi-directional transfer of electronic medical records, portions thereof, or instructions.

In one embodiment, the at least one physician practice may be both a requestor and a performer. In an alternate embodiment, the at least one physician practice may be a requestor, then a performer.

In one embodiment, the at least one performing diagnostic testing services provider may be both a performer and a requestor. In an alternate embodiment, the at least one performing diagnostic testing services provider may be a performer then a requestor.

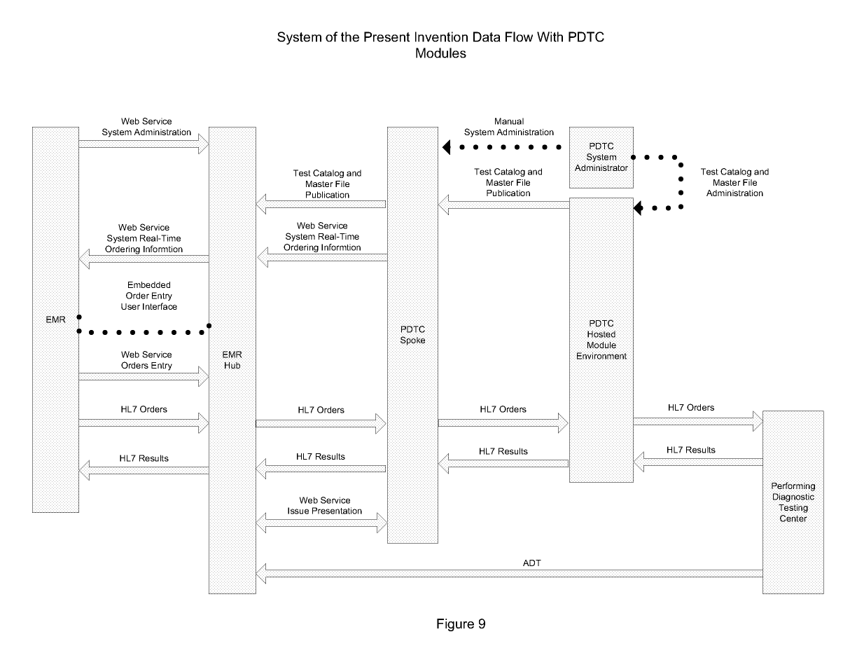

Referring to FIG. 9, in one embodiment, the electronic medical records, or portions thereof, or instructions may pass to and from the performing diagnostic testing services provider and the lab spoke through an additional software module. This module may be located within the system of the present invention. Alternatively, it may be located outside the system of the present invention. The additional software module may facilitate additional functionalities, such as manipulating the electronic information, or, alternatively, performing specific tasks, or reporting specific results. These may include for example, lab test result reporting, lab test ordering, prescriptions, referrals, billing, statistical analysis, and the like.

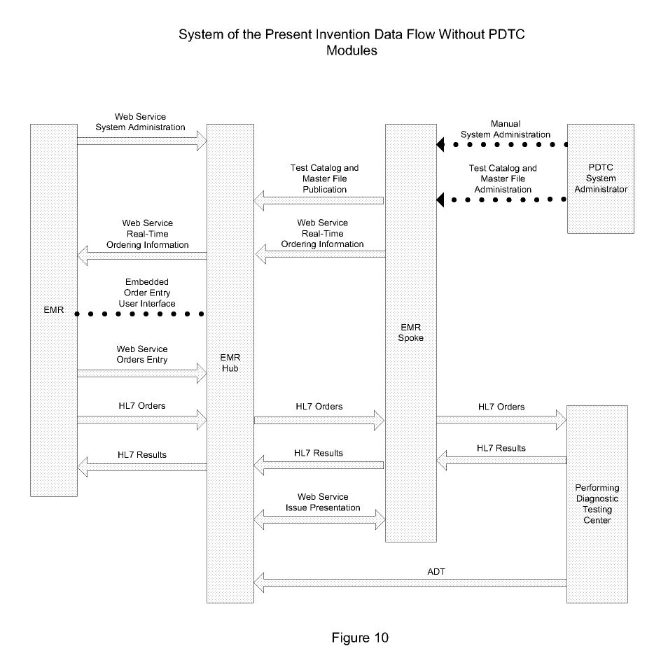

Referring to FIG. 10, in one embodiment, the electronic medical records, or portions thereof, or instructions may pass to and from the performing diagnostic testing services provider and the lab spoke without an additional software module.

In one embodiment, the system of the present invention is located on a single server. In an alternate embodiment, the system of the present invention is located on more than one server.

In one embodiment, the system of the present invention has an overarching infrastructure that defines, performs and monitors the electronic data file flow to and from requestors and performers. The overarching infrastructure is referred to herein as “Nucleus”.

In one embodiment, Nucleus allows a system administrator to define permitted electronic data file flow paths to, from, and between each spoke and hub. This definition includes the rules that determine the spoke and hub path to be taken for each particular electronic data file based on the file's content, requestor, and performer. The definition may also include a particular set of file content transformation rules that occur when a file is moved to, from, or between particular spokes and hubs.

In one embodiment, Nucleus physically transports the electronic data files to, from, and between each spoke and hub. The transfer of electronic medical records, or portions thereof, or instructions from the spoke to the at least one performing diagnostic testing services provider may be via any method contemplated by one of ordinary skill in the art, such as, for example, HTTPS, VPN, web services, URL, or file flow.

In one embodiment, Nucleus performs any file content transformation defined for the particular path to, from, or between any particular spokes and hubs.

In one embodiment, Nucleus tracks each electronic data file that is transported along with information that identifies the content of the data file such as the requestor and performer transaction ID. This is used to track and report each electronic data file flow occurrence.

In one embodiment, Nucleus periodically creates and transports testing files that simulate electronic data flow to, from, and between spokes and hubs. Nucleus transports these testing files through spokes and hubs to the destination point, prior to the electronic data file being delivered to an external requestor or performer. The testing files are used to verify that the spokes, hubs, and Nucleus are working properly. The absence of receiving these testing files at each destination point within a period of time triggers a system administration alert. In one embodiment, the testing files are referred to as “tracer bullets”.

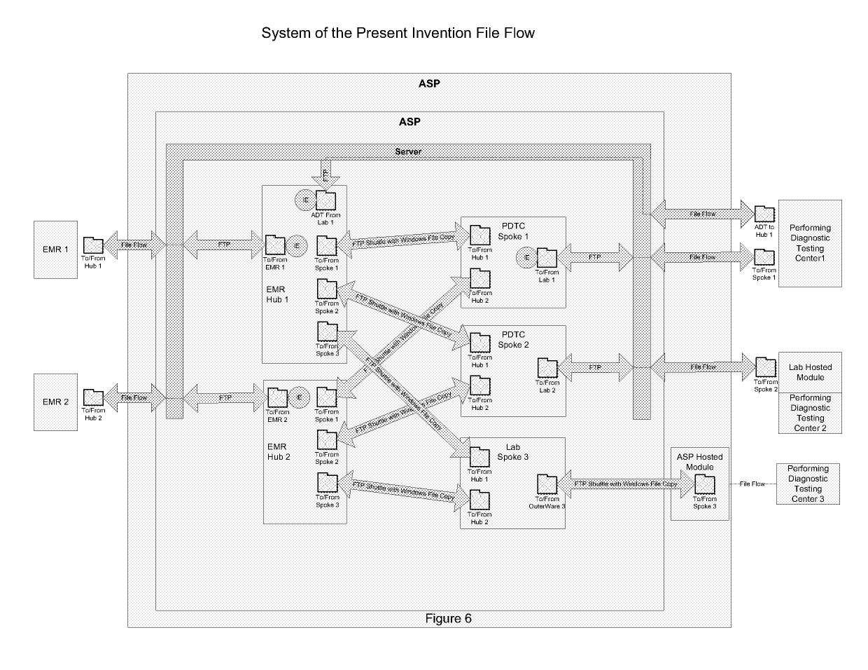

FIGS. 6 to 8 illustrate embodiments that implement Nucleus. In the embodiment shown in FIG. 6, the system of the present invention is a contained within a server, which is capable of facilitating the transfer of electronic medical records, or portions thereof, or instructions between EMR hubs and lab spokes utilizing file transfer protocols. One skilled in the art will appreciate the vast interconnective capability utilizing this model.

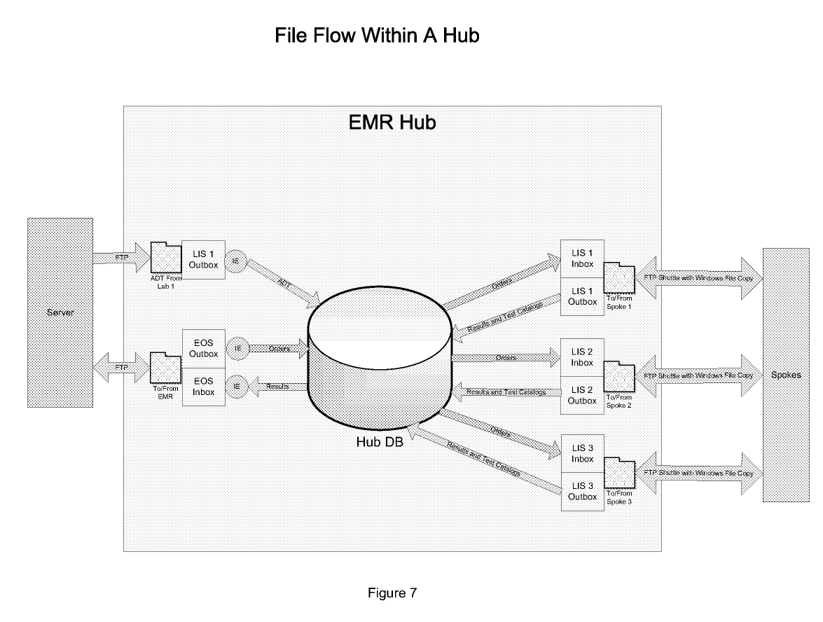

Referring to FIG. 7, in one embodiment, an EMR hub of the system of the present invention contains a database, which in turn facilitates the routing of electronic medical records, or portions thereof, or instructions to and from the lab spokes.

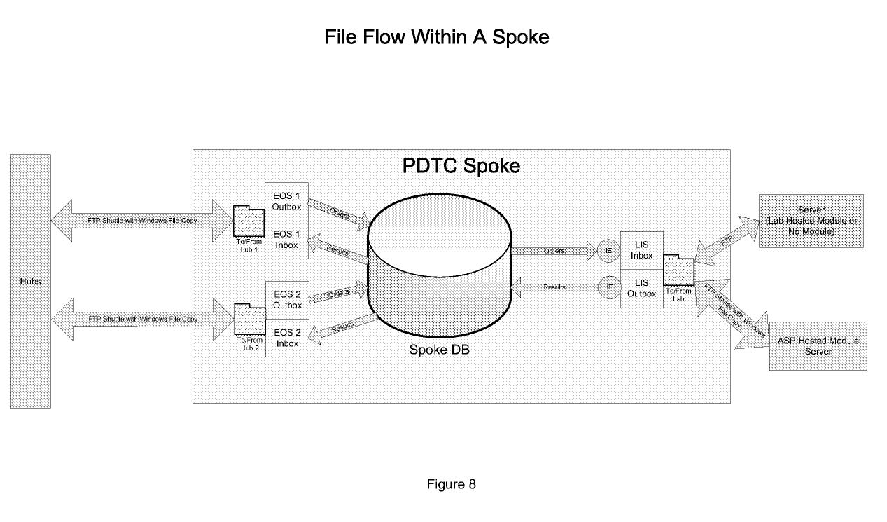

Referring to FIG. 8, in one embodiment, a lab spoke of the system of the present invention contains a database, which in turn facilitates the routing of electronic medical records, or portions thereof, or instructions to and from the EMR hubs.

Publications cited throughout this document are hereby incorporated by reference in their entirety. Although the various aspects of the invention have been illustrated above by reference to examples and preferred embodiments, it will be appreciated that the scope of the invention is defined not by the foregoing description but by the following claims properly construed under principles of patent law.

What is claimed is:

1. A system that interfaces at least one requestor to at least one performer, wherein the at least one requestor is able to transfer electronic information, or portions thereof, ubiquitously with the at least one performer, such that the at least one performer and the at least one requestor receive the electronic information transferred in a format that they can manage the electronic information regardless of the format that the at least one requestor and the at least one performer manage their respective electronic information.

2. The system of claim 1, wherein instructions related to processes and procedures that modify the electronic information also are part of the electronic information transferred.

3. The system of claim 1, wherein the at least one performer is first a performer, then a requestor.

4. The system of claim 3, wherein the at least one performer becomes a requestor in response to instructions received from the at least one requestor.

5. The system of claim 1, wherein the at least one requestor is first a requestor, then a performer.

6. The system of claim 5, wherein the at least one requestor becomes a performer in response to instructions received from the at least one performer.

7. The system of claim 1, wherein the electronic information is electronic medical records.

8. A method of transferring electronic information between any number of requestors and performers utilizing the system of claim 1.

9. A system that interfaces at least one requestor to at least one performer, wherein the at least one requestor is able to transfer instructions related to processes and procedures that modify electronic information to the at least one performer such that the at least one performer and the at least one requestor receive the electronic information transferred in a format that they can manage the electronic information regardless of the format that the at least one requestor and the at least one performer manage their respective electronic information.

10. The system of claim 9, wherein the at least one performer is first a performer, then a requestor.

11. The system of claim 10, wherein the at least one performer becomes a requestor in response to instructions received from the at least one requestor.

12. The system of claim 9, wherein the at least one requestor is first a requestor, then a performer.

13. The system of claim 12, wherein the at least one requestor becomes a performer in response to instructions received from the at least one performer.

14. The system of claim 9, wherein the electronic information is electronic medical records.

15. A method of transferring electronic information between any number of requestors and performers utilizing the system of claim 9.
